(19) United States
(12) Patent Application Publication
(10) Pub. No.: US 2002/0014992 A1
(43) Pub. Date: Feb. 7, 2002

(54) Reconfigurable aperture antenna using shape memory material

(76) Inventors: Liang Q. Sun, Vienna, VA (US); Amir I. Zaghloul, Bethesda, MD (US)

Correspondence Address: C. Dennis Ahearn, Assistant General Counsel for Intellectual Prop., COMSAT Corporation, 22300 Comsat Drive,, Clarksburg, MD, 20871, US

(21) Appl. No.: 09/781,573

(22) Filed: Feb. 12, 2001

Related U.S. Application Data
(60) Provisional application No. 60/181,758, filed on Feb. 11, 2000.

(51) Int. Cl. H01Q 1/48

(52) U.S. Cl. 343/700 MS; 343/846

(57) ABSTRACT

A patch antenna made from shape memory materials that can change the antenna configuration to have different apertures for operations at different frequencies. The antenna is constructed so that several different shape memory materials having different activation temperatures are used for different portions of the antenna. The temperature of the antenna controls the frequency at which the antenna radiates. The antenna is designed so that at a temperature below that of the activation temperature of any of the shape memory materials it consists of a single large flat radiating patch antenna that radiates at a lowest frequency F1. As the temperature is increased to the activation temperature of the first active shape memory material components, these components deform from their base flat shape and assume a different shape such as an inverted “U” and break contact with the adjacent antenna components, thereby subdividing the former single large radiating patch antenna into two or more smaller radiating patch antennas that radiate at a higher frequency F2. As the temperature is further increased to the activation temperature of the second active shape memory material components, these components deform from their base flat shape and assume a different shape such as an inverted “U” and break contact with the adjacent antenna components, thereby further subdividing the previous multiple radiating patch antennas into smaller radiating patch antennas that radiate at a higher frequency F3. This process can be repeated again to further subdivide the previous multiple radiating patch antennas into still smaller radiating patch antennas that radiate at a higher frequency F4.

### CLAIM OF PRIORITY

This application claims priority of provisional application 60/181,758 filed Feb. 11, 2000 in the names of Liang Q. Sun and Amir I. Zaghloul.

### FIELD OF THE INVENTION

This invention relates generally to antennas for the reception and transmission of radio communications signals. More particularly, it relates to flat antennas that use patch array elements for the radiating and/or receiving elements. Further, and most particularly, it relates to flat patch antennas that can be reconfigured so as to be able to transmit/receive in more than one frequency range.

### BACKGROUND OF THE INVENTION

In modern telecommunications applications, there is frequently a need by a user of such communications to transmit or receive communications signals at two or more frequencies. The frequency range of communication system applications is expanding to include unused or little used higher frequency bands such as Ka-, V- or W-bands, in addition to commonly used bands such as L-, S-, C-, X- and Ku-bands. Switching from one frequency band to another has become a requirement in some systems in order to increase the overall frequency band that can be used. When these different frequencies are separated from each other by a large enough difference in frequency, an antenna that is designed and optimized to operate at the first frequency may not be able to efficiently operate at the second frequency.

A second antenna designed and optimized to operate at the second frequency can be employed to utilize the second frequency, but this use of a second antenna results in a number of negative effects for the user, such as the increased costs of purchasing and operating two separate antennas, the additional hardware involved with a second antenna, the necessity to switch from one antenna to the other when it is desired to use the second frequency, the need for operations personnel to be trained on both antennas and the increased opportunity for problems to develop requiring maintenance due to the increased amount of equipment that is being used. Such negative effects can become especially important when mobile communications systems are involved which require that a minimum of equipment be used and that such equipment be able to be rapidly moved from one location to another, be operated by a minimum number of personnel, be rugged and able to switch from one frequency to another as rapidly as possible, and be as inexpensive as possible.

One solution to this problem has been to use reconfigurable antennas that change antenna elements so as to be able to operate efficiently at different frequencies. One example of this is the use of two different feed horn assemblies with a standard parabolic dish antenna. In this example, the antenna is set up to have the first feed horn assembly situated at the appropriate point in front of the antenna to operate at the first frequency. When it is desired to operate at the second frequency, the first feed horn assembly is physically moved from this point and the second feed horn assembly is moved to the appropriate point in front of the antenna for it to operate at its frequency and is installed. Operations can then begin at the second frequency. However, this solution has numerous drawbacks including requiring that the feed horn elements be physically moved, requiring a significant delay in being able to switch to operations at the second frequency and requiring relatively complex equipment to implement this solution.

Another solution to this problem has been to install multiple feed horns in a group at a point in front of the antenna and to switch electronically to the feed horn(s) that are needed for operation at a particular frequency. This is a much more rapid solution to this problem, but the equipment required to implement this solution can be complex, bulky and relatively expensive. In addition, the greater size of the feed horn assembly required for this solution can reduce the effective sensitivity of the antenna system by blocking a larger area of the parabolic dish from receiving signals.

In array designs, interleaving of arrays can produce the same result as the use of separate feed horns, but the coupling that occurs between elements of the interleaved arrays creates design difficulties that must be addressed. Other array designs use multiple band elements with the element spacing in terms of wavelength varying at every frequency band, resulting in very different patterns of radiation at different bands.

In order to solve the problem of having an antenna system that can operate at two or more widely separated frequencies, it is desirable to have a single reconfigurable antenna that will be compact, relatively inexpensive, simple to operate and able to change frequencies rapidly and without any manual intervention. The invention described herein overcomes many of the negative effects of previous attempts to solve the problems of operating at multiple frequencies by proposing a single flat patch antenna made from shape memory materials that can reconfigure itself rapidly and without physical intervention by an operator to operate at two or more frequencies.

### SUMMARY OF THE INVENTION

A reconfigurable patch antenna system using shape memory materials (hereinafter “SMM”) according to the invention is set forth to allow operation of the antenna over a large range of frequencies by using changes in temperature to activate the shape memory properties of the SMM and thereby change the effective aperture of the antenna, thus changing the frequency at which the antenna system operates. This method of constructing a reconfigurable patch antenna system can cover several frequency bands, such as L-band to Ka-band, in a single overall antenna size while maintaining repeatable performance at any particular band.

Using the SMM alloys allows reshaping the radiating elements in a patch array, with maintaining the element spacing approximately constant in terms of the wavelength. Because the radiating elements of the antenna change their shape, only a single array exists at a time, with no possible coupling between the arrays operating at different frequencies since multiple arrays are not present at the same time. The unique properties of the SMM alloys (such as nickel titanium (NiTi)) make them a perfect choice for wide band reconfigurable antennas.

The example given in this specification uses alloys of nickel titanium (NiTi) as the SMM to form the antenna array elements, but it is to be understood that other materials having shape memory properties can be used as well, and that the invention is not restricted to nickel titanium alloys. The NiTi alloy is a well known material that has shape memory effects, meaning that the material can be formed into one shape (such as a flat sheet which will be its normal or unactivated shape) at one temperature and formed into a second shape at a higher temperature equal to or above the activation temperature of the particular SMM. After the SMM has been formed into the second shape at a temperature above its activation temperature, it will have “memorized” this second shape and will return to this shape when its temperature is later raised above the activation temperature. At a later time when the piece of SMM is at a temperature below its activation temperature, it will be in its normal or base shape. When it is then heated to a temperature equal to or above its activation temperature, it will rapidly reassume its memorized shape and remain in such memorized shape until its temperature falls below the activation temperature, at which point it will reassume its base shape. An item made from SMM can thus predictably change its shape according to the environmental temperature. While this specification uses SMM items that assume a different shape at a higher temperature, it would also be possible to use SMM items that have the reverse property, namely that their base state is at a higher temperature and they will assume a different shape at a lower temperature, and the invention described herein could also be used with such materials, although the temperature flows would have to be the reverse of those given in the examples in this specification.

In this invention, a patch antenna is made from two or more different NiTi alloys that have different activation temperatures. The different alloys are used to make different radiating patch elements of the antenna in accordance with the principles of this invention. The number of alloys used will depend on how many different frequencies it is desired at which to operate the antenna system made according to this invention. The choice of the elements to be made from each type of alloy will depend on the design characteristics of the antenna system. This specification will use as an example an antenna system that uses four (4) different SMM alloys of NiTi and is capable of operating at four (4) frequencies. The design example used here employs the various SMM materials to construct an antenna that is composed of one (1), four (4), sixteen (16) or one hundred forty-four (144) radiating patch elements depending on the temperature of the antenna.

Below the activation temperature of any of the SMM materials used, the antenna will consist of a single large patch that will operate at one particular frequency determined by the overall size of the antenna, its initial or largest aperture. At this time, the single large patch will consist of a mosaic of smaller patch elements made from the various SMM alloys, and all of the elements will be in electrical contact with their neighboring elements, thus acting together as a single radiating element. The temperature of the antenna (or only of certain portions of the antenna) will then be raised until it equals or exceeds the activation temperature of the SMM having the lowest activation temperature. At this point, all of the elements made from this SMM assume their memorized shape, thus breaking contact with their neighboring elements and separating the original single large patch radiating element into four (4) smaller patch radiating elements that will radiate at a higher frequency depending on the overall size of each of these patches. The aperture of the antenna will thus have been effectively decreased to the size of the aperture of each of the four radiating patches. The temperature of the antenna (or only of certain other portions of the antenna) will be raised until it equals or exceeds the activation temperature of the SMM having the next lowest activation temperature. At this point, all of the elements made from this SMM also assume their memorized shape, thus breaking contact with their neighboring elements and separating each of the four previous patch radiating elements into four (4) smaller patch radiating elements for a total of sixteen (16) radiating patch elements. These sixteen radiating patch elements will radiate at a still higher frequency depending on the overall size of each of these patches. The aperture of the antenna will then have been effectively decreased to the size of the aperture of each of the sixteen radiating patches. The temperature of the antenna (or only of certain other portions of the antenna) will be raised until it equals or exceeds the activation temperature of the SMM having the next lowest activation temperature. At this point, all of the elements made from this SMM assume their memorized shape, thus breaking contact with their neighboring elements and separating each of the sixteen previous patch radiating elements into nine (9) smaller patch radiating elements for a total of one hundred forty-four (144) radiating patch elements. These one hundred forty-four radiating patch elements will radiate at the highest frequency and that frequency will depend on the overall size of each of these patches. The aperture of the antenna will thus have been effectively decreased to the size of the aperture of each of the one hundred forty-four radiating patches.

By designing an antenna system in accordance with this invention, the application of temperature increases to the antenna will selectively activate the shape memory properties of one set of array elements after another, and the cooling of the array elements will reverse this process. The change in the shape of the SMM array elements to and from their memorized shapes will result in fast reconfigurations of the array aperture, leading to changing the array operating frequency. The environmental temperature of the array thus changes the array configuration and its operating frequency.

### BRIEF DESCRIPTION OF THE DRAWINGS

FIG. 1 is a drawing showing the elements of an antenna according to this invention at a temperature below that necessary to activate the shape memory properties of the shape memory material and at a temperature equal to or above the activation temperature for the shape memory material;

FIG. 2 is a drawing of one embodiment of the invention using four (4) different shape memory material alloys at a temperature below the activation temperature of any of the alloys;

FIG. 3 is a drawing of one embodiment of the invention using four (4) different shape memory material alloys at a temperature equal to or above the temperature necessary to activate the second shape memory material but below the activation temperature of third and fourth alloys;

FIG. 4 is a drawing of one embodiment of the invention using four (4) different shape memory material alloys at a temperature equal to or above the temperature necessary to activate the second and third shape memory materials but below the activation temperature of fourth alloy;

FIG. 5 is a drawing of one embodiment of the invention using four (4) different shape memory material alloys at a temperature equal to or above the temperature necessary to activate the second, third and fourth shape memory materials; and

FIG. 6 is a drawing of an embodiment of a complete prototype of the invention showing the positioning of the various components of the complete antenna system.

### DESCRIPTION OF THE INVENTION

While the antenna system according to this invention can perform at a number of frequency bands, it is a patch antenna system that operates in a similar manner to other patch antenna systems in that it utilizes a ground plane (not illustrated), a feeding network (not illustrated) and dielectric layers (not illustrated) in a conventional manner. The exact shapes of the radiating elements and feed network elements and the relative positioning of the radiating elements, the feed network elements and the ground plane will be determined by the antenna designer in accordance with the operational requirements of the antenna system and antenna design principles that are well known in relation to patch antennas. The feeding network can be designed to consist of a printed circuit network, a pin feed network or other types of feeding arrangements that are well known in the art. The requirements of how to feed the various arrays of radiating patches that are part of this invention can be met through the use of appropriate filters, phase shifters, amplifiers, power dividers or combiners, and other frequency dependent circuits in ways that are apparent to those skilled in the art.

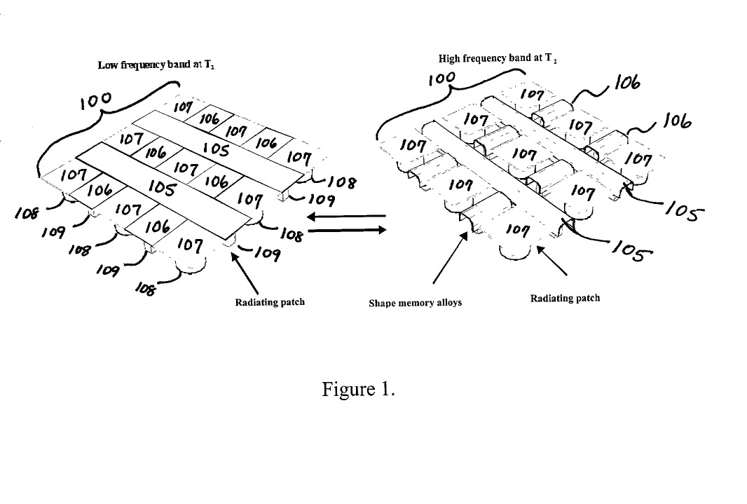

FIG. 1 illustrates the basic idea for the reconfigurable aperture antenna using shape memory materials to change the aperture of the antenna when some elements are heated to a temperature that activates the shape memory properties of these elements. As illustrated in FIG. 1, two different SMMs are used so that one SMM will respond at a given activation temperature T1 to change its shape to its previously memorized shape while the second SMM will remain unaffected.

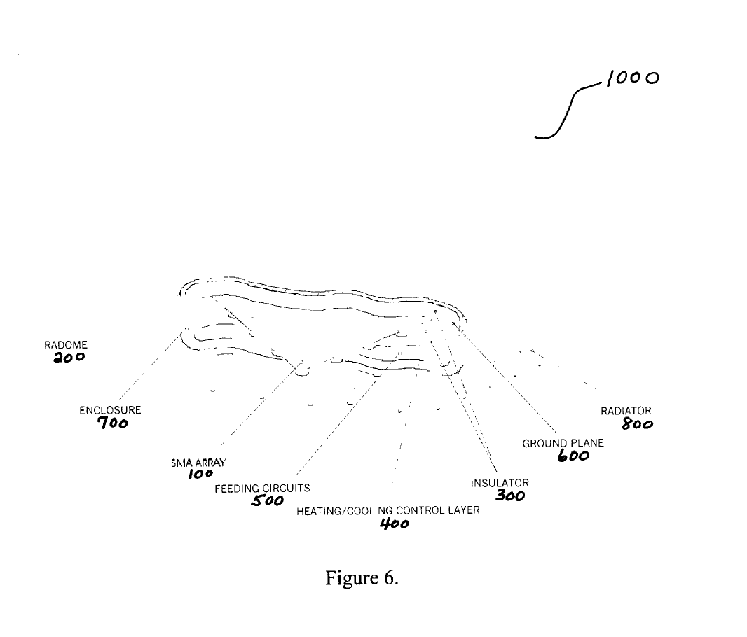

In FIG. 1, the left side of the Figure shows a radiating patch element 100 made from two different SMMs (two different alloys of NiTi that have different activation temperatures) at a temperature below the activation temperature of either type of SMM. On this side of FIG. 1, all of the elements 105, 106 and 107 are in their base, unactivated state. The right side of FIG. 1 shows what happens when the temperature of the array is at or above the activation temperature of the first SMM. In this Figure, elements 107 are made from one type of SMM (one alloy of NiTi) and the elements 105 and 106 are made from the second type of SMM (a second alloy of NiTi). As shown on the left side of FIG. 1, at temperatures below the activation temperature of elements 105 and 106, all of the elements 105, 106 and 107 are in electrical contact with each of their neighboring elements and they form a single large radiating patch element 100. This radiating patch element 100 is fed from its central point or otherwise as determined by the antenna designer and will radiate at a frequency determined by the overall size of the patch 100. As shown on the right side of FIG. 1, at temperatures equal to or above the activation temperature of elements 105 and 106, these elements assume their previously memorized shapes, disconnecting themselves from each other and from all of the elements 107. All of the elements 105 and 106 are disconnected from any feeding source so they do not radiate at all, leaving only the elements 107 to act as radiating patches. Each of the elements 107 is fed from its central point or as otherwise determined by the antenna designer. Each radiating element 107 now radiates at the same frequency determined by the overall size of the patch 107 and this frequency is a higher frequency than the radiating frequency of the former large radiating element 100. The elements 108 and 109 in FIG. 1 act as supports for the elements 105, 106 and 107 as indicated and are made from an appropriate dielectric material. Elements 108 and 109 will have holes through them at appropriate locations within their bodies to allow a connection from the feeding layer (shown in FIG. 6 as No. 500) to be made to the elements 107 and in some cases to selected ones of elements 105 and 106 as described below. All or some of elements 108 and 109 may, in some variations of this invention, contain heating and cooling means to be used to more directly control the temperature of the elements 105, 106 and 107 associated with such elements 108 and 109.

In any antenna system made according to this invention, the composition of the elements 107 will be a basic consideration. In the preferred embodiment described herein, it is intended that the elements 107 as well as all of the other elements 101-106 be made from various alloys of NiTi. These elements 107 can be made in either of three ways: first by choosing an alloy of NiTi that has a higher activation temperature than the antenna will ever generate; second, by choosing an alloy of NiTi that is the same as the NiTi alloy chosen for other of the elements 101-106 but not treating the elements 107 to any form of shape memorization so that will remain flat at all temperatures; or third, by choosing an alloy of NiTi different from the alloys used from the elements 101-106 regardless of its activation temperature but not treating these elements 107 with any shape memorization. The choice of which method to use for the elements 107 is a design consideration for the antenna designer. The preferred embodiment described here employs the third alternative.

It is also possible to make the elements 107 from a material that is different from the SMMs used to make elements 101-106. Since the elements 107 never change their shape, it is not required that they be made from an SMM. It is essential that the elements 107 and the elements 101-106 have similar conductive and radiative properties so that groupings of elements 107 and 101-106 can act as a single radiating patch efficiently. It is also important that the materials used for the elements 107 and the elements 101-106 have similar thermal expansion characteristics so that electrical contact between the various elements can be maintained as the temperature of the antenna changes and so that there will not be any buckling along the joints between the various elements as the temperature increases and the elements expand. Such decisions on the materials to use for the elements 107 are a matter of choice for the antenna designer.

The size and shape of the elements 107 will be a fundamental consideration to the design of the overall antenna since the overall antenna is built up from combinations of various numbers of elements 107 (and the elements 101-106) into larger patches. The choice of the size and shape for element 107 will determine the highest frequency at which the antenna will operate. The choice of the size and shape of the elements 101-106 will determine the lower frequencies at which the antenna will operate in the other configurations of patch radiators that are made up from the combinations of elements 107 and 101-106 made in accordance with the principles of this invention. These choices are at the discretion of the antenna designer and will be made in accordance with well known principles in the art based on the operating frequencies that are desired for a particular antenna.

Underlying each element 105 and 106 in the preferred embodiment is an element 109 that supports its associated element. The element 109 is designed to allow the associated element 105 or 106 to bend downwards when the activation temperature is reached and break its contacts with the other elements to which it had been in contact at temperatures below its activation temperature. In some variations of this invention, the elements 109 may be designed to contain heating and/or cooling means to enable more direct control over the temperature of its associated element 105 or 106. Since in this case an additional purpose of the element 109 is to rapidly change the temperature of its associated element 105 or 106, any means that has this ability and that can fit within the confines of the desired antenna structure can be used for the element 109. The simplest form of element 109 would be a heater wire that would generate the necessary heat to raise the temperature of its associated element when a current was applied to it. Cooling would then take place either through a normal radiative loss of heat when the current was turned off or a fan could be used to more rapidly remove heat from the affected elements. Such a heating/cooling combination would allow for rapid changes from low to high frequencies of operation by allowing for rapid increases in temperature but would not be as rapid in going from a high frequency operation to a lower frequency operation due to the relative slowness of removing the necessary heat from the system to resume operations at a lower frequency. This problem could be overcome by either the use of a fan that sent refrigerated air into the antenna enclosure or by combining a refrigeration line into the elements 109 so that heat could be removed from the SMM elements associated with the elements 109 much more rapidly. The design of the elements 109 will thus be dependent on the designer's requirements for the speed with which increases and decreases in the temperature of the SMM elements that change their shape must be made. The use of heating lines combined with cooling lines in the elements 109 could thus be used to allow for the most rapid changes in temperature so that switches between frequencies can be made as rapidly as possible.

Thermal control of this antenna system thus plays a central role in its operation. Another possible structure that can be used for heating and cooling and that is simpler than the preferred embodiment described above is the use of a thermal control layer to perform heating and cooling for the antenna as a whole through the use of electrical thermal materials and Peltier Coolers. This is the method of heating and cooling used in the preferred embodiment due to its lower cost and reduced complexity. Heating is controlled by the thermal materials, such as standard heating wires, and takes place by generating heat when a current is run through the thermal materials. Cooling utilizes the Peltier Cooler, a miniature solid state device, that lowers the temperature in an area very quickly. Utilizing the Peltier effect, these modules perform the cooling as freon-based refrigerators, but they do it with no moving parts, and are very reliable. Electric current applied to the device produces cold temperature on the topside and heat on down side; up to 68° C. difference between the two sides. The heat drawn off the top side can be vented from the system in a number of ways. As shown in FIG. 6, the preferred embodiment uses radiation vanes attached to the antenna enclosure for their simplicity and low cost. Modules can be mounted in parallel to increase the heat transfer effect or can be stacked to achieve higher differential temperatures. They operate on 3-12 Vdc. The invention is not limited to these methods of heating and cooling, however, and alternative methods of performing these functions will be known to those skilled in the art.

A preferred embodiment of the invention will now be described. In this embodiment, several different NiTi alloys are selected based on their compositions so that they would have different activation temperatures for an antenna designed to operate at four different frequencies ranging from L- to Ka-bands. Four different alloys can be used at different shape activation temperatures. One is plain NiTi alloy, which can be used for the Ka-band radiating element 107. The second (NiTi2) will respond to T₁, (around 40° C.), the third (NiTi3) will respond to T₂ (around 60° C.), and the fourth (NiTi4) will respond at T₃ (around 80° C.). The basic element size for the elements 107 from which the aperture will be formed is 5×5 mm and is used as a Ka-band radiating element operating at a frequency of 30 GHz. This high frequency operation is achieved at the high temperature of 80° C. when all of the SMM elements 101-106 have been activated and are no longer radiating and only the elements 107 are acting as radiating elements. As the operating frequency decreases, larger size radiating elements will be required and formed by properly combining the elements 107 with selected ones of the elements 101-106 to form larger radiating patches. This build-up of larger radiating patches from the smaller elements will be done in such a manner that appropriate separation between elements is maintained to avoid grating lobes.

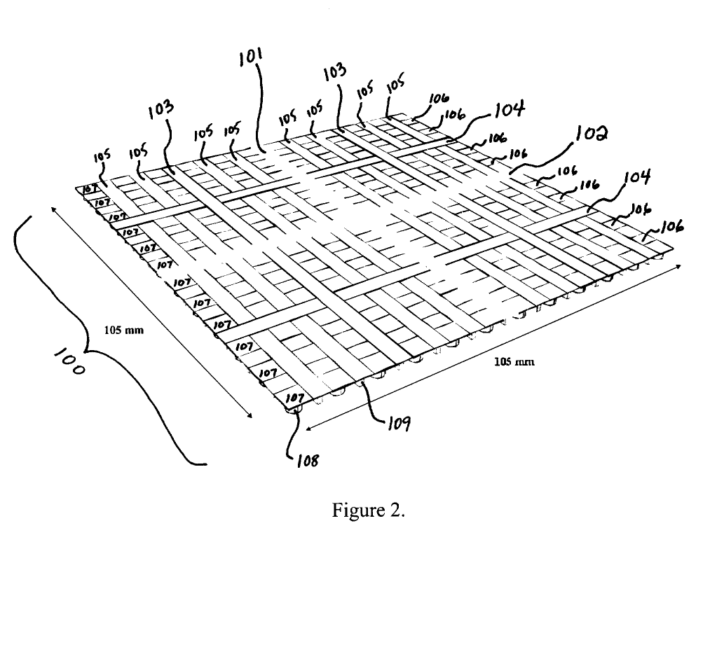

As shown in FIG. 2, the preferred embodiment operates at the lowest frequency (L-band) when it is at a temperature below that of the activation temperature of any of the SMM elements (in this example, a temperature less than the 40° C. activation temperature of the NiTi2 alloy), and a single antenna patch will be formed by combining all of the smaller elements at room temperature as shown in FIG. 2. The size of this patch 100 is 105×105 mm and all of the elements of the antenna are in electrical contact with each of their neighboring elements. All of the SMM elements are in their base state at this time. The patch will be fed at its center, or at such other location or locations as determined by the antenna designer, to form a single radiating element. The substrate material will be foam with a dielectric constant of 1.05, which is very close to the dielectric constant of air. The thickness of the substrate is about 2.5 mm. In this Figure and in the preferred embodiment, elements 101 and 102 are formed from the second NiTi alloy (NiTi2)which has an activation temperature of approximately 40° C., elements 103 and 104 are formed from the third NiTi alloy (NiTi3) which has an activation temperature of approximately 60° C., and elements 105 and 106 are formed from the fourth NiTi alloy (NiTi4) which has an activation temperature of approximately 80° C. In this embodiment, no heating or cooling is applied through the elements 109 which underlie each of the elements 101-106.

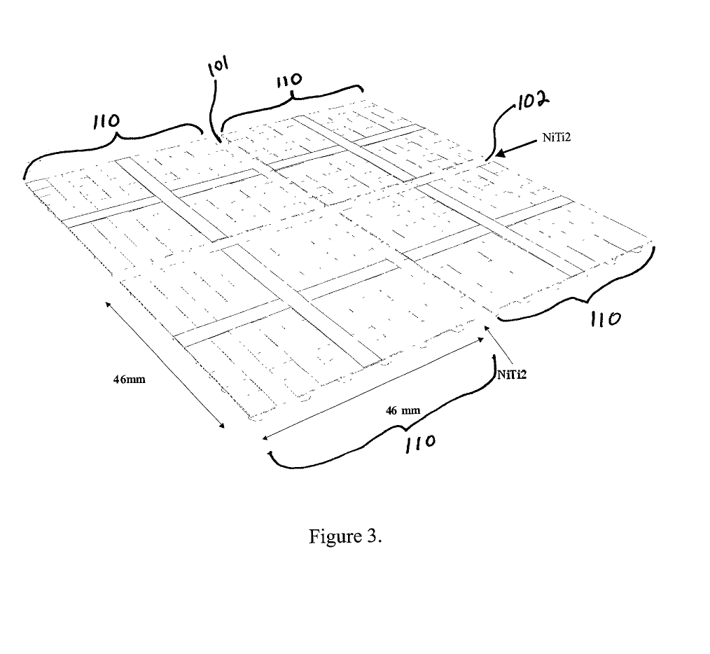

When it is desired to switch to the next higher frequency of operation, FIG. 3 sets forth the reconfiguration of the antenna elements that will take place. Current will be applied to the heating elements contained in the thermal control layer, thereby raising the temperature of the antenna and elements 101 and 102 to 40° C. At this temperature, the NiTi2 in the elements 101 and 102 will be deformed to an inverted-U shape (or such other shape as is determined to be preferable) and these elements will disconnect themselves from the adjoining elements to form a 2×2 element antenna array, as shown in FIG. 3. The size of each radiating element 110 formed at this temperature becomes 46×46 mm, and the operating frequency of these radiating elements will be approximately 3 GHz. Each patch will be fed at its center, or at such other location or locations as determined by the antenna designer, to form a single radiating element. Depending on the particular design used, this center point or the other chosen feed points may be under an element 107 or an element 103-106. The distance between the new-formed patches will be 54 mm.

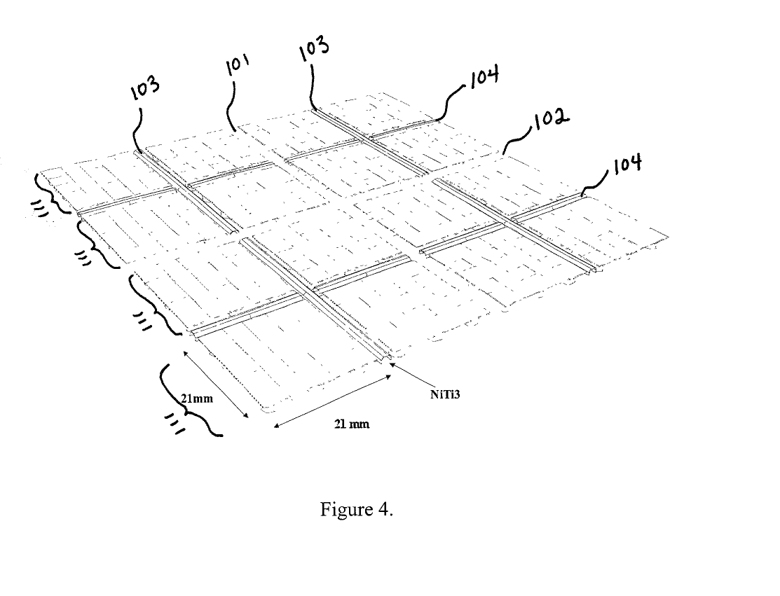

When it is desired to switch to the next higher frequency of operation, FIG. 4 sets forth the reconfiguration of the antenna elements that will take place. Current will be applied to the heating elements contained in the thermal control layer, thereby raising the temperature of the antenna and elements 103 and 104 to 60° C. At 60° C., the NiTi3 in the elements 103 and 104 will respond to the temperature and change its flat shape to an inverted-U shape (or such other shape as is determined to be preferable). The original L-band antenna patch will now have been reconfigured to a 4×4 antenna array, shown in FIG. 4. Now the size of each radiating patch element 111 is 21×21 mm, and the operating frequency of these radiating elements will be approximately 6 GHz. The patch will be fed at its center, or at such other location or locations as determined by the antenna designer, to form a single radiating element. Depending on the particular design used, this center point or the other chosen feed points may be under an element 107 or an element 105 or 106. The distance between the elements is 27 mm.

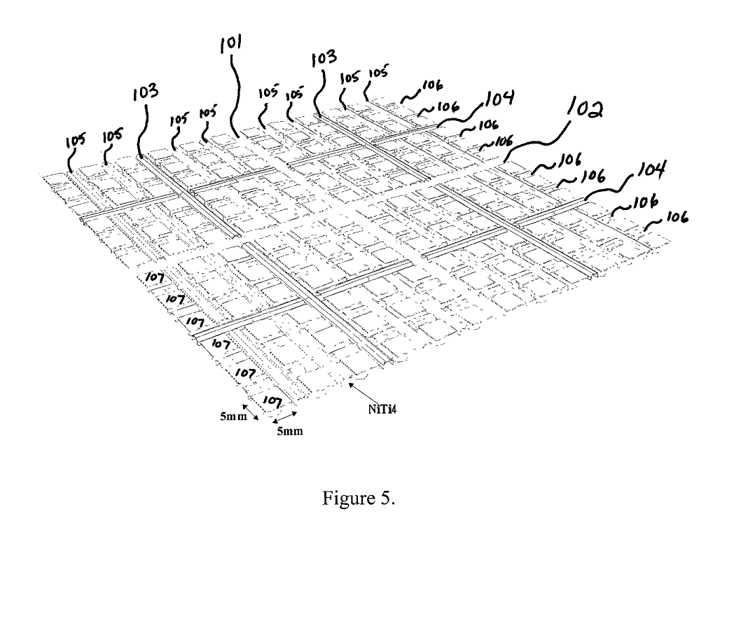

Finally, when it is desired to switch to the highest frequency of operation, FIG. 5 sets forth the reconfiguration of the antenna elements that will take place. Current will be applied to the heating elements contained in the thermal control layer, thereby raising the temperature of the antenna and elements 105 and 106 to 80° C. At 80° C. the NiTi4 in the elements 105 and 106 will respond to the temperature and change its flat shape to an inverted-U shape (or such other shape as is determined to be preferable). The original L-band antenna patch will now have been reconfigured to a 12×12 antenna array, as shown in FIG. 5, and the size of each radiating patch element 107 is 5×5 mm, and the operating frequency of these radiating elements will be approximately 30 GHz. Each radiating patch 107 will be fed at its center, or at such other location or locations as determined by the antenna designer. The distance between the elements is 9 mm.

In one variation of the preferred embodiment, current could also be applied to the heating means contained in elements 109 that underlie elements 101-106. This might enable a more rapid heating control system to be utilized in the antenna since the heat could be applied directly to the appropriate SMM elements.

The reconfigurable aperture method described above provides the proper distance between radiation elements at each band. The proposed design has a broad flexibility. Since the overall size of the antenna that can be made from shape memory materials can be varied as required by antenna design requirements, the size of each band element can be redesigned according to different frequency requirements in accordance with well known principles in the art. The particular example given above is only one of many possible designs and is not a limitation on the invention disclosed herein.

A possible realization of a whole antenna using the reconfigurable aperture method described herein is shown in FIG. 6. Since thermal control is important to the realization of the benefits of this invention, an antenna unit housing that allows for the rapid removal of heat from the SMM elements should be employed. Many such units are possible and will be apparent to the antenna designer knowledgeable in this field. Possible designs include ones using forced air cooling from fans or refrigeration units or ones using refrigeration lines as part of the cooling elements 109 described above. Another choice would be the use of a thermal control layer and Peltier units as described above. Combinations of such cooling methods may also be used and are within the scope of this invention. As shown in FIG. 6, the use of a thermal control layer is illustrated.

Referring to FIG. 6, the antenna system 1000 will be enclosed in a weatherproof radome unit 200 that will be made of standard radome materials and will be attached to the enclosure 700 in a standard manner for such attachments. The combination of the radome 200 and the enclosure 700 will contain the antenna unit. In order to promote rapid cooling of the internal structure of the antenna, radiator vanes 800 are attached to the back of the enclosure 700 in accordance with the well known methods for attaching such vanes to such enclosures. Inside the antenna unit and starting from radome 200 and proceeding downwards towards the radiator vanes 800, the first layer immediately adjacent to the radome 200 is an insulator layer 300 which isolates the heat generated by the antenna from the radome. Below the insulator layer 300 will be the radiating SMM array layer 100 which will be atop the substrate supporting the elements of the SMM array layer (the elements 108 and 109 from FIG. 1). Immediately below the substrate elements layer will be the ground plane layer 600. Immediately below the ground plane layer there is a thermal control layer 400 followed by another insulator layer 300 which is followed by the electronic feeding network layer 500. In this embodiment, the thermal control layer uses standard heating circuits and Peltier coolers to control the temperature of the overall antenna, and separate heating and cooling means are not made a part of the substrate elements 108 and 109. An alternative design could eliminate the thermal control layer altogether and use heating and cooling means as part of the elements 108 and 109. Another alternative design could use a combination of both the thermal control layer and heating and cooling means as part of the elements 108 and 109. The electronic feeding network layer 500 is connected to the antenna radiating elements in SMM layer 100 through the holes in the insulator layer 300, the thermal control layer 400 and the ground plane 600. This connection could be made with standard probe connections going from the feeding network layer 500 to the SMM layer or through use of coaxial cables. Capacitive coupling between the feeding layer and the radiating layer may also be used. The electronic feeding layer 500 contains appropriate filters (not shown and well known to those skilled in the art) connected to the feedlines that lead to each of the feeding points that feed the associated radiating elements in SMM layer 100 so that the correct feeding points are active only when the frequency desired is the frequency for which the filter is designed to allow to pass. Other methods of activating the correct feeding points at the correct time will be apparent to those skilled in the art. The extra heat will be taken out through the radiator vanes 800.

While the antenna system 1000 shown here is a square antenna, the invention is not limited to square antenna systems but can apply to any shape of antenna including circular, rectangular or any other shape. The modification of the shapes of the elements 101-107 that might be desired for use with antennas which are not square will be obvious to those skilled in the art and are within the scope of this invention. Additional variations will be apparent to those skilled in the art. For example, although the feeding points for each radiating patch element have been described as being in the center of that patch, the feeding points may be offset from the center, or placed at the edge of the patch or there may be two feeding points per patch in accordance with principles well known in the art applicable to patch antennas if the use of different polarizations, including circular polarization, is desired. Thus the invention is not limited to the specific details and illustrative examples shown and discussed in the specification. Rather, it is the object of the claims to cover all such variations and modifications as come within the true spirit and scope of this invention.

What is claimed is:

1. A patch antenna made from shape memory materials that is capable of operating at two different frequencies, wherein:
a first shape memory material is chosen as the material from which the smallest radiating patch elements of the antenna are made;
a second shape memory material is chosen as the material from which other antenna elements are made;
the radiating patch elements made from the first shape memory material are not treated to assume any different shape from their base shape if the temperature of the elements is raised above the activation temperature of the first shape memory material;
the antenna elements made from the second shape memory material are treated to assume a different shape from their base shape if the temperature of the elements is raised above the activation temperature of the second shape memory material;
the radiating patch elements made from the first shape memory material and the antenna elements made from the second shape memory material are adjacent to each other and in electrical contact with each other and form a single flat radiating element at a temperature below the activation temperature of the second shape memory material and that single radiating element radiates at a frequency F1;
the antenna elements made from the second shape memory material change their shape when the temperature of the antenna is raised to or above the activation temperature of the second shape memory material while the radiating patch elements made from the first shape memory material do not change their shape, and the antenna elements made from the second shape memory material are then no longer in electrical contact with the radiating patch elements made from the first shape memory material and no longer radiate, thereby leaving the radiating patch elements as separate radiating elements that radiate at a frequency F2 which is higher than the frequency F1.
